(19) United States
(12) Patent Application Publication
(10) Pub. No.: US 2025/0003631 A1
(43) Pub. Date: Jan. 2, 2025

(54) VENTILATION TYPE SILENCER

(71) Applicant: FUJIFILM Corporation, Tokyo (JP)

(72) Inventors: Shinya HAKUTA, Kanagawa (JP); Shogo YAMAZOE, Kanagawa (JP); Yuichiro ITAI, Kanagawa (JP); Yoshihiro SUGAWARA, Kanagawa (JP)

(73) Assignee: FUJIFILM Corporation, Tokyo (JP)

(21) Appl. No.: 18/885,817

(22) Filed: Sep. 16, 2024

Related U.S. Application Data
(63) Continuation of application No. PCT/JP2023/000626, filed on Jan. 12, 2023.

(30) Foreign Application Priority Data
Mar. 31, 2022 (JP) 2022-059462

(51) Int. Cl. F24F 13/24

(52) U.S. Cl. CPC F24F 13/24; F24F 2013/242

(57) ABSTRACT

A ventilation type silencer includes a ventilation channel in which at least a part of a side wall of a flow channel of a gas is formed of a porous sound absorbing material, in which a flow resistance of the sound absorbing material is 1000 Rayls/m or more, porosity of the sound absorbing material on at least a flow channel surface side is 0.9 or less or permeability thereof is 3.0×10⁻⁹ m² or less, and a minimum flow channel width on a cross section perpendicular to a flow direction of the gas in the ventilation channel is 100 mm or less. As a result, the ventilation type silencer is provided, which includes the porous sound absorbing material that can be appropriately selected for the flow channel of the gas in accordance with hydrodynamic characteristics of the sound absorbing material in a case in which the porous sound absorbing material is used in at least a part of the flow channel, that can suppress a pressure loss, and that can reduce a wind noise.

### CROSS-REFERENCE TO RELATED APPLICATIONS

This application is a Continuation of PCT International Application No. PCT/JP2023/000626 filed on Jan. 12, 2023, which claims priority under 35 U.S.C. § 119(a) to Japanese Patent Application No. 2022-059462 filed on Mar. 31, 2022. The above applications are hereby expressly incorporated by reference, in their entirety, into the present application.

### BACKGROUND OF THE INVENTION

### 1. Field of the Invention

The present invention relates to a ventilation type silencer, and more particularly, to a ventilation type silencer comprising a porous sound absorbing material on a side wall of a ventilation channel.

### 2. Description of the Related Art

A ventilation silencer is known in which, in a ventilation channel for transporting a gas, a sound absorbing material is installed on a side wall of the ventilation channel in order to silence noise from a gas supply source or the like during transport of the gas.

For example, JP1995-229415A (JP-H07-229415A) discloses an expansion type silencer in which gas flow pipes are attached to both front and rear ends of a cylindrical container, and a sound absorbing material is attached to an inner surface of a side wall of the container. As such a silencer, a silencer in which a radial thickness of the sound absorbing material is the same as an axial direction and an inner surface of the sound absorbing material is a circumferential surface having the same radius, and a silencer which is improved from the silencer and in which the radial thickness of the same sound absorbing material varies in order in the axial direction and the inner surface of the sound absorbing material is a tapered surface are disclosed. As the sound absorbing material, a foam body of a synthetic resin, glass wool, a web made of a fibrous material, and the like are disclosed. In this technology, in a case in which the inner surface of the sound absorbing material is the tapered surface, and thus a noise frequency range is wide, a silencing effect can be improved by making silencing characteristics match a wide noise frequency range.

### SUMMARY OF THE INVENTION

However, in the expansion type silencer disclosed in JP1995-229415A (JP-H07-229415A), there is a problem in that loud wind noise is generated in a case in which the wind flows into an expansion chamber, and there is a problem in that a pressure loss may be increased.

As described above, in the ventilation type silencer, in a case in which the porous sound absorbing material is used in a flow channel, the pressure loss and/or the wind noise may vary depending on the sound absorbing material, and thus it is necessary to select an appropriate sound absorbing material for the flow channel of the ventilation silencer, but the technology disclosed in JP1995-229415A (JP-H07-229415A) has a problem in that an appropriate sound absorbing material cannot be selected.

An object of the present invention is to solve the problems in the related art and to provide a ventilation type silencer comprising a porous sound absorbing material that can be appropriately selected for a flow channel of a gas in accordance with hydrodynamic characteristics of the sound absorbing material in a case in which the porous sound absorbing material is used in at least a part of the flow channel, that can suppress a pressure loss, and that can reduce a wind noise.

In order to achieve the above-described object, a first aspect of the present invention provides a ventilation type silencer comprising: a ventilation channel in which at least a part of a side wall of a flow channel of a gas is formed of a porous sound absorbing material, in which a flow resistance of the sound absorbing material is 1000 Rayls/m or more, porosity of the sound absorbing material on at least a flow channel surface side is 0.9 or less, and a minimum flow channel width on a cross section perpendicular to a flow direction of the gas in the ventilation channel is 100 mm or less.

Here, it is preferable that the sound absorbing material is formed of two or more sound absorbing material layers, porosity of the sound absorbing material layer that is an outermost layer on the flow channel surface side is 0.9 or less, and the sound absorbing material layer having porosity of 0.9 or more is included in second and subsequent layers.

In order to achieve the above-described object, a second aspect of the present invention provides a ventilation type silencer comprising: a ventilation channel in which at least a part of a side wall of a flow channel of a gas is formed of a porous sound absorbing material, in which a flow resistance of the sound absorbing material is 1000 Rayls/m or more, permeability of the sound absorbing material on at least a surface side is 3.0×10⁻⁹ m² or less, and a minimum flow channel width on a cross section perpendicular to a flow direction of the gas in the ventilation channel is 100 mm or less.

Here, it is preferable that porosity of the sound absorbing material on at least a flow channel surface side is 0.9 or less.

In addition, it is preferable that the sound absorbing material is formed of two or more sound absorbing material layers, and permeability of the sound absorbing material layer that is an outermost layer on a flow channel surface side is 3.0×10⁻⁹ m² or less.

In addition, it is preferable that porosity of the sound absorbing material in the sound absorbing material layer that is the outermost layer on a flow channel surface side is 0.9 or less.

In the first and second aspects of the present invention, it is preferable that the flow channel is circular.

In addition, it is preferable that the flow channel is rectangular.

In addition, it is preferable that the ventilation type silencer further comprises: a flow channel formation member; and a claw or a support for fixing the sound absorbing material to a side wall surface of the flow channel formation member.

In addition, it is preferable that a portion of the sound absorbing material and a portion of a non-sound absorbing material are connected to each other via a shape in which a cross-sectional area of the ventilation channel is gradually widened.

The aspects of the present invention provides the ventilation type silencer comprising the porous sound absorbing material that can be appropriately selected for the flow channel of the gas in accordance with hydrodynamic characteristics of the sound absorbing material in a case in which the porous sound absorbing material is used in at least a part of the flow channel, that can suppress a pressure loss, and that can reduce a wind noise.

### BRIEF DESCRIPTION OF THE DRAWINGS

FIG. 1 is a longitudinal sectional view schematically showing an example of a ventilation type silencer according to an embodiment of the present invention.

FIG. 2 is a longitudinal sectional view schematically showing another example of the ventilation type silencer according to the embodiment of the present invention.

FIGS. 3A to 3D are each a transverse sectional view schematically showing an example of the ventilation type silencer according to the embodiment of the present invention.

FIG. 4 is a longitudinal sectional view schematically showing another example of the ventilation type silencer according to the embodiment of the present invention.

FIGS. 5A and 5B are each a partial longitudinal sectional view schematically showing an example of the ventilation type silencer according to the embodiment of the present invention.

FIG. 6 is a longitudinal sectional view schematically showing a ventilation type silencer used for measurement of a pressure loss.

FIG. 7 is a graph showing a relationship between a pressure loss of a porous sound absorbing material measured by the ventilation type silencer shown in FIG. 6 and a wind velocity.

FIG. 8 is a graph showing a relationship between permeability of a porous sound absorbing material used in the embodiment of the present invention and a pressure loss.

FIG. 9 is a graph showing a relationship between the permeability of the porous sound absorbing material used in the embodiment of the present invention and a wind noise.

FIG. 10 is a graph showing a relationship between porosity of the porous sound absorbing material used in the embodiment of the present invention and the pressure loss.

FIG. 11 is a graph showing a relationship between the porosity of the porous sound absorbing material used in the embodiment of the present invention and the wind noise.

FIG. 12 is a graph showing a relationship between a flow resistance of the porous sound absorbing material used in the embodiment of the present invention and a normal incidence sound absorption coefficient.

FIG. 13 is an example of an acoustic pipe used for measurement of the normal incidence sound absorption coefficient shown in FIG. 12.

FIG. 14 is a graph showing a relationship between a flow channel width of a ventilation channel of the ventilation type silencer according to the embodiment of the present invention and a pressure loss.

### DESCRIPTION OF THE PREFERRED EMBODIMENTS

Hereinafter, a ventilation type silencer according to an embodiment of the present invention will be described in detail with reference to a preferred embodiment shown in the accompanying drawings.

The configuration requirements are described below based on a representative embodiment of the present invention, but the present invention is not limited to such an embodiment.

It should be noted that, in the present specification, a numerical range represented by “to” means a range including numerical values described before and after “to” as a lower limit value and an upper limit value.

### [Ventilation Type Silencer]

The ventilation type silencer according to the embodiment of the present invention is a ventilation type silencer including a ventilation channel in which at least a part of a side wall of a flow channel of a gas is formed of a porous sound absorbing material, in which a flow resistance of the sound absorbing material is 1000 Rayls/m or more, porosity of the sound absorbing material on at least a flow channel surface side is 0.9 or less and/or permeability of the sound absorbing material on at least the flow channel surface side is 3.0×10⁻⁹ m² or less, and an average of a smaller flow channel width out of a flow channel width of a side wall of the flow channel and a flow channel width of a sound absorbing material side wall formed of the sound absorbing material is 100 mm or less.

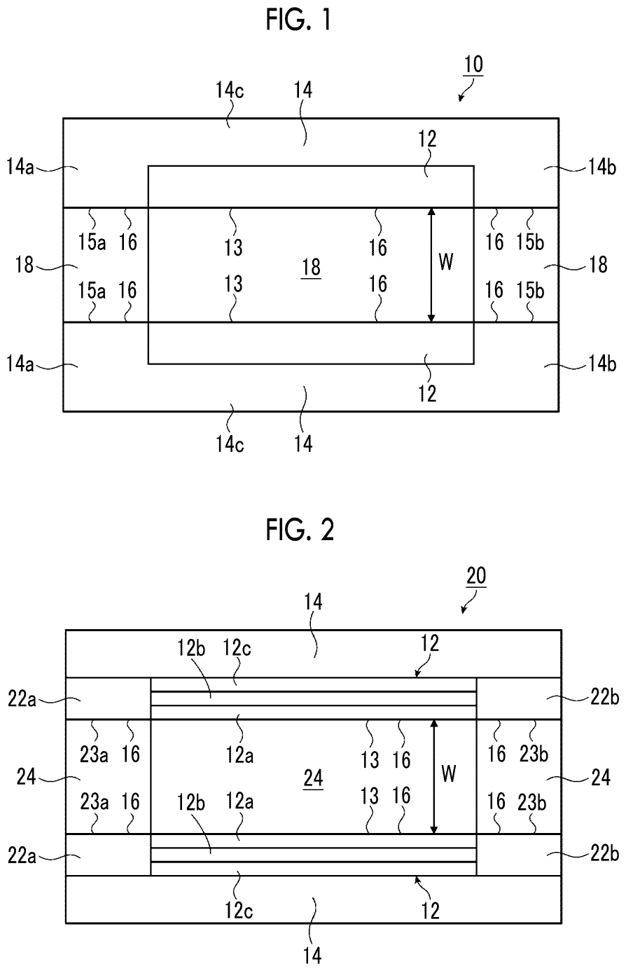

FIG. 1 is a longitudinal sectional view schematically showing an example of the ventilation type silencer according to the embodiment of the present invention, and FIG. 2 is a longitudinal sectional view schematically showing another example of the ventilation type silencer according to the embodiment of the present invention.

As shown in FIG. 1, a ventilation type silencer 10 includes a tubular porous sound absorbing material 12 and a flow channel formation member 14 that supports the porous sound absorbing material 12 with an internal flow channel expansion part 14c. An inner wall surface 13 of the porous sound absorbing material 12 constitutes a side wall 16 of the flow channel. In addition, the flow channel formation member 14 includes flow channel formation parts 14a and 14b that constitute the flow channel on both an upstream side and a downstream side of the flow channel expansion part 14c, and inner wall surfaces 15a and 15b of the flow channel formation parts 14a and 14b also constitute the side wall 16 of the flow channel.

In this way, the inner wall surface 13 of the porous sound absorbing material 12 and the inner wall surfaces 15a and 15b of the flow channel formation parts 14a and 14b of the flow channel formation member 14 constitute one side wall 16 of the flow channel, and the flow channel formed by the side wall 16 formed of the inner wall surfaces 15a, 13, and 15b serves as a ventilation channel 18. That is, the ventilation channel 18 is an entire flow channel of the gas. It should be noted that, hereinafter, the porous sound absorbing material may be simply referred to as a sound absorbing material.

The porous sound absorbing material 12 in the ventilation type silencer 10 shown in FIG. 1 is a single layer, but the present invention is not limited to this, and the porous sound absorbing material may be formed of two or more layers. For example, as in a ventilation type silencer 20 shown in FIG. 2, the porous sound absorbing material 12 may be formed of three sound absorbing material layers 12a, 12b, and 12c.

In addition, in the ventilation type silencer 10 shown in FIG. 1, the side wall 16 of the flow channel of the gas constituting the ventilation channel 18 is formed of the inner wall surface 13 of the porous sound absorbing material 12 and the inner wall surfaces 15a and 15b of the flow channel formation member 14, but the present invention is not limited to this. For example, as in the ventilation type silencer 20 shown in FIG. 2, the ventilation channel 18 may be formed of the gas flow pipe supported by the flow channel formation member 14 as long as a part of the side wall 16 of the flow channel of the gas is formed of the porous sound absorbing material 12.

That is, the ventilation type silencer 20 shown in FIG. 2 includes a ventilation channel 24 formed of a tubular gas flow pipe 22a, the tubular porous sound absorbing material 12 connected to the gas flow pipe 22a, and a gas flow pipe 22b connected to the porous sound absorbing material 12. Here, the gas flow pipes 22a and 22b may be any pipes as long as the pipes are used for allowing the gas to flow, need only be, for example, metal pipes or plastic pipes, and may be the same type of pipes or different types of pipes.

In the ventilation type silencer 20, the side wall 16 of the flow channel of the gas is formed of an inner wall surface 23a of the gas flow pipe 22a, the inner wall surface 13 of the porous sound absorbing material 12, and an inner wall surface 23b of the gas flow pipe 22b, and the ventilation channel 24 is formed of a flow channel consisting of the inner wall surfaces 23a, 13, and 23b. It should be noted that it is preferable that the porous sound absorbing material 12, the gas flow pipe 22a, and the gas flow pipe 22b have outer surfaces supported by the inner wall surface of the flow channel formation member 14.

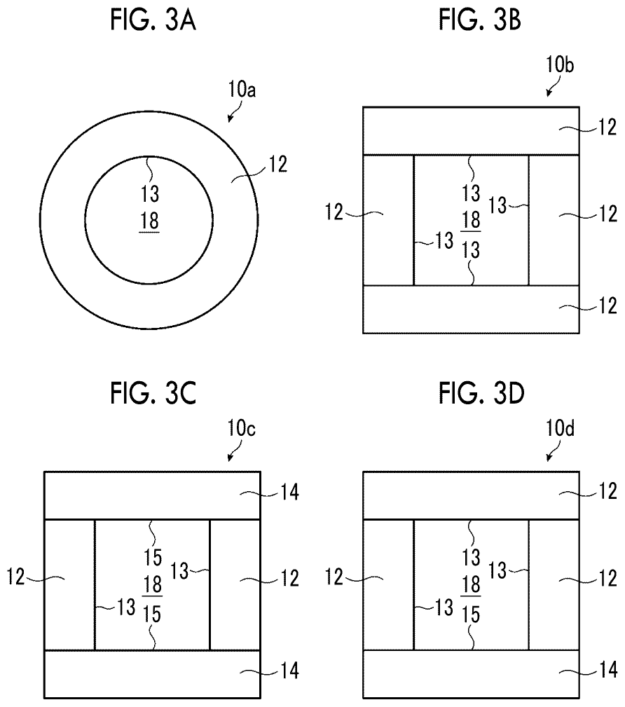

In both the ventilation type silencer 10 shown in FIG. 1 and the ventilation type silencer 20 shown in FIG. 2, the flow channel constituting the ventilation channels 18 and 24 is not particularly limited as long as the gas can flow smoothly and gently, and may have any shape and structure. A cross-sectional shape of the flow channel may be any shape, but the cross-sectional shape is preferably circular as shown in FIG. 3A or rectangular as shown in FIGS. 3B to 3D.

Although the ventilation channel 18 shown in FIG. 1 is formed of the inner wall surface 13 of the porous sound absorbing material 12 and the inner wall surfaces 15a and 15b of the flow channel formation member 14, the present invention is not limited to this. In the ventilation channel 18, at least a part of the side wall in a longitudinal direction of the flow channel of the gas, for example, at least a part of the side wall in the longitudinal direction in which the gas flows as shown in FIGS. 1 and 2, or at least a part of the flow channel in a transverse sectional direction as shown in FIGS. 3B to 3D need only be formed of the porous sound absorbing material 12.

For example, the ventilation channel 18 may be formed of one of the inner wall surface 13, the inner wall surface 15a, or the inner wall surface 15b, or one of the inner wall surface 23 or the inner wall surface 23b, or may be formed only of the inner wall surface 13 of the porous sound absorbing material 12, along the longitudinal direction, as shown in FIG. 1 or 2.

In addition, a cylindrical column-shaped flow channel may be used in which the ventilation channel 18 is formed of a circular inner wall surface 13 of a cylindrical porous sound absorbing material 12 as in a ventilation type silencer 10a of which a transverse section is shown in FIG. 3A, and a square column-shaped flow channel may be used in which the ventilation channel 18 is formed of a rectangular inner wall surface 13 of a square tube-shaped porous sound absorbing material 12 formed of four plate-shaped porous sound absorbing materials 12 as in a ventilation type silencer 10b of which a transverse section is shown in FIG. 3B.

That is, as shown in FIGS. 3A and 3B, the entire periphery of the ventilation channel 18 in the transverse sectional direction may be formed of the porous sound absorbing material 12.

In addition, as in a ventilation type silencer 10c shown in FIG. 3C, only two facing surfaces of the ventilation channel 18 formed of a square tube-shaped flow channel of which a transverse sectional shape is rectangular may be formed of the inner wall surface 13 of a plate-shaped porous sound absorbing material 12, and the other two surfaces thereof may be formed of the inner wall surface 15 of the flow channel formation member 14.

In addition, as in a ventilation type silencer 10d shown in FIG. 3D, three surfaces in total, including two facing surfaces of the ventilation channel 18 formed of a square tube-shaped flow channel of which a transverse sectional shape is rectangular and one surface of the other two surfaces, may be formed of the inner wall surface of a plate-shaped porous sound absorbing material 12, and the remaining one surface may be formed of the inner wall surface 15 of the flow channel formation member 14.

That is, as shown in FIGS. 3C and 3D, at least a part of the ventilation channel 18 in the transverse sectional direction may be formed of the porous sound absorbing material 12.

It should be noted that, in FIGS. 3A to 3D, the flow channel formation member 14 that supports the porous sound absorbing material 12 is not shown, and the entire flow channel formation member 14 comprising the inner wall surface 15 constituting at least one surface of the ventilation channel 18 is also not shown.

In addition, in the longitudinal direction of the flow channel, a size of the transverse sectional shape of the flow channel may be changed, but it is preferable that the size is not changed, and it is preferable that the transverse sectional shape is a straight linear shape. That is, it is preferable that a flow channel width of the flow channel constituting the ventilation channels 18 and 24 is constant, but the flow channel width may be gradually narrowed or gradually widened as long as a change in the flow channel width does not cause a sudden change in a flow of the gas. That is, it is preferable that the facing side walls of the flow channel constituting the ventilation channels 18 and 24 are parallel to each other, but the facing side walls may gradually approach each other or may gradually move away from each other.

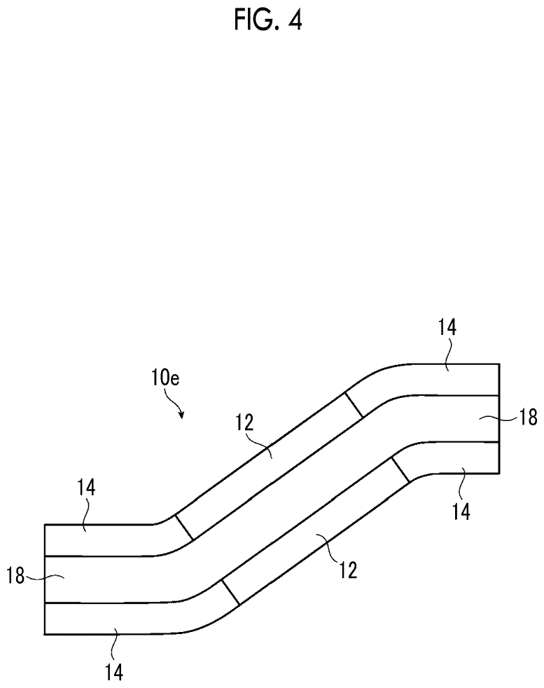

In addition, as in the ventilation type silencer 10e shown in FIG. 4, the ventilation channel 18 itself may be oblique instead of being linear. In this case as well, it is desirable that a sudden change is not caused in the flow of the gas, and it is desirable that the sound absorbing material 12 is not disposed at a position at which a sudden change is caused in the flow of the gas. For example, as in the ventilation type silencer 10e shown in FIG. 4, a change in the flow is large at a part in which the flow channel (ventilation channel 18) is bent, and thus it is desirable that the part is formed of the wall (for example, the flow channel formation member 14) and the sound absorbing material 12 is disposed in the remaining part.

Therefore, in the ventilation channel 24 of the ventilation type silencer 20 shown in FIG. 2, in a case in which the inner wall surface 23a of the gas flow pipe 22a, the inner wall surface 13 of the porous sound absorbing material 12, and the inner wall surface 23b of the gas flow pipe 22b are connected smoothly to each other without a step, the flow channel width of the flow channel formed by each of inner wall surfaces may be smoothly changed.

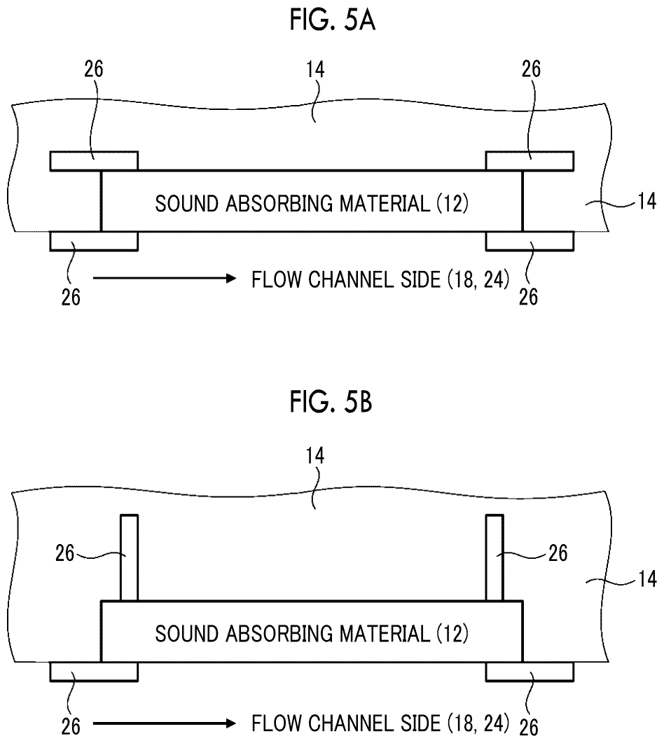

It should be noted that the ventilation type silencers 10 and 20 have the flow channel formation member 14, and it is preferable that the ventilation type silencers 10 and 20 include a claw or a support 26 for fixing the porous sound absorbing material 12 to a side wall surface of the flow channel formation member 14, as shown in FIGS. 5A and 5B. As a result, the porous sound absorbing material 12 does not fall into sound absorbing material flow channels of the ventilation channels 18 and 24.

Meanwhile, the present inventors have found the following with regard to the porous sound absorbing material.

First, in a case in which a fibrous sound absorbing material having a large cavity portion and a large number of cavity portions, that is, a so-called sparse and fluffy fibrous sound absorbing material, in which porosity is large, is used as the porous sound absorbing material, a wind noise and a pressure loss are larger than those in a case in which a densely filled sound absorbing material is used. That is, a wind velocity and differential pressure characteristics depend on a structure of the sound absorbing material (in a case of being sparse and fluffy or in a case of being densely filled), and are greatly changed by the sound absorbing material.

In addition, such a wind noise and such a pressure loss largely depend on a surface of the porous sound absorbing material, and are different between a front surface and a back surface in a case of a two-layered sound absorbing material.

In addition, such a wind noise and such a pressure loss are not closely correlated with the flow resistance that determines the sound absorption, but the correlation may be reversed.

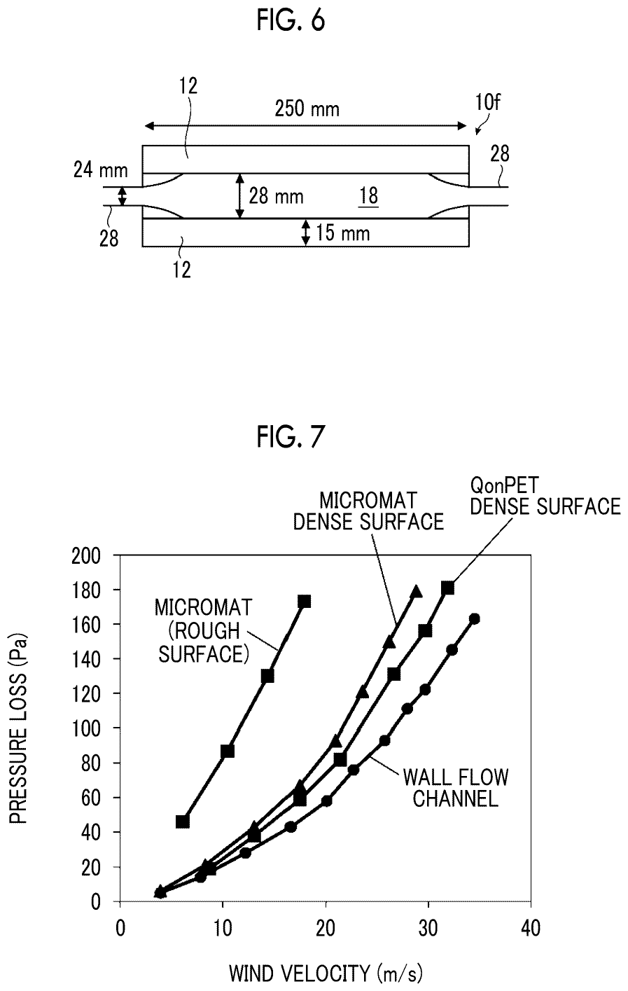

The present inventors performed actual measurement as an example of the sound absorbing material having a horn-equipped flow channel to which a horn member shown in FIG. 6 was attached.

A hose of 24 mm was prepared, a Sirocco fan was connected to one end of the hose, and wind was generated with a wind volume such that an internal wind velocity of the hose was 0 to 40 m/s. A silencer 10f formed of the sound absorbing material flow channel (ventilation channel) 18 shown in FIG. 6 was disposed at the other end of the hose. The silencer 10f was a rectangular silencer having one inner side of 58 mm, and had a shape in which the inside was adjusted to have one side of 28 mm of a rectangular flow channel (ventilation channel) 18, and the porous sound absorbing material 12 having a thickness of 15 mm was disposed between the wall and the rectangular flow channel 18.

The horn 28 was attached to both ends of the silencer 10f in order to smoothly connect the hose and the rectangular flow channel 18 of the silencer 10f. A length of the horn 28 was 21 mm, and a length of the entire silencer 10f was 250 mm. The other side of the silencer 10f was also connected to the hose of Ø24 mm.

The pressure loss was measured by measuring a differential pressure between the positions 370 mm away from the end parts of the silencer 10f by a manometer.

As the sound absorbing material, a micromat having a thickness of 15 mm and QonPET were used.

First, in a case in which a sparse side (rough surface) of the micromat was defined as the flow channel side (porosity of 0.95 and permeability of 5×10⁻⁹ (m²)), as indicated as the micromat (rough surface) in the graph of FIG. 7, the pressure loss was extremely large, and the pressure loss was 4 times that of the wall flow channel in a case of the wind velocity of 17 m/s. Therefore, this case corresponds to the comparative example.

Next, since the micromat was a laminate of a dense nonwoven fabric surface and a sparse nonwoven fabric layer, and the measurement was performed with the dense nonwoven fabric disposed on the flow channel side (the dense nonwoven fabric surface had the porosity of 0.5 and the permeability of 1×10⁻⁹ (m²)). Even with the same micromat, in a case in which the dense surface was disposed on the flow channel side, as indicated as the micromat dense surface in the graph of FIG. 7, the pressure loss was reduced to less than 40%. The pressure loss was 1.6 times that of the wall flow channel at the wind velocity of 20 m/s. Therefore, this case corresponds to the present invention example.

The same measurement was performed with the dense nonwoven fabric surface of the denser QonPET disposed on the flow channel side (the dense nonwoven fabric surface had the porosity of 0.3 and the permeability of 0.1×10⁻⁹ (m²)). In a case of using the QonPET, as indicated by the QonPET dense surface in the graph of FIG. 7, the pressure loss was further reduced as compared with the micromat, and the pressure loss could be suppressed to 1.4 times that of the wall flow channel. Therefore, this case also corresponds to the present invention example.

The present invention has been made based on the findings that, in order to obtain a high sound absorption, a low pressure loss, and a low wind noise in the ventilation type silencer including the ventilation channel using the porous sound absorbing material, it is necessary to consider the hydrodynamic characteristics and the structure of the porous sound absorbing material, the size of the ventilation channel, and the orientation in a case of a sound absorbing material of a multilayer structure having different front and back surfaces.

Therefore, in the present invention, it is necessary to consider parameters of a porous fluid, which is called Darcy's law, specifically, porosity and permeability.

Here, in a case in which the permeability is K (m²), a flow rate of the fluid is Q (m³/s), a length of the flow channel is L (m), the cross-sectional area of the flow channel is A (m²), a pressure difference is ΔP (Pa), and the viscosity is μ (Pa·s), the following expression is obtained.

$$Q / A = K \times Δ P / μ / L \\ K = Q \times μ \times L / ( Δ P \times A )$$

Here, in the present invention, the porosity of the porous sound absorbing material 12 needs to be 0.9 (90%) or less, and/or the permeability of the porous sound absorbing material 12 needs to be 3.0×10⁻⁹ m² or less.

It should be noted that, in a case in which the porous sound absorbing material 12 has a multilayer structure of two or more layers, the physical properties depending on the structure of the porous sound absorbing material in the outermost surface layer directly affect the flow of the gas.

Therefore, in the porous sound absorbing material 12, it is preferable that the porosity of the sound absorbing material layer that is the outermost layer on the flow channel surface side is 0.9 or less, and the sound absorbing material layer having the porosity of 0.9 or more may be included in the second and subsequent layers.

In addition, in the porous sound absorbing material 12, it is preferable that the permeability of the sound absorbing material layer that is the outermost layer on the flow channel surface side is 3.0×10⁻⁹ m² or less.

It should be noted that the porosity and the permeability of the porous sound absorbing material 12 can be obtained with reference to the following documents.

https://www.comsol.com/blogs/computing-porosity-and-permeability-in-porous-medi a-with-a-submodel/

In addition, the porosity is defined as a volume of the fluid (air) in the material (porous sound absorbing material)/an apparent volume, but can also be measured according to the following documents.

“Air based system for the measurement of porosity.

Yvan Champoux, etc. JASA 89 (2) 1991, pp 910”

Accordingly, in a case of measuring the porosity of the porous sound absorbing material (sound absorbing material), first, the sound absorbing material to be measured is disposed in a large airtight container. Next, a pressure change inside the airtight container is measured in a case in which a volume of the airtight container is slightly changed.

Next, by using the combined gas law (pressure×volume is constant under the constant temperature condition), an internal volume change is obtained from the pressure change, and a volume of an air part of the airtight container is known, so that the air volume inside the sound absorbing material can be measured (that is, only the volume of the fluid inside the sound absorbing material responds to the combined gas law, so that the volume of the fluid inside the sound absorbing material can be calculated from the pressure change).

In addition, the porosity may be obtained by performing an X-ray CT scan of the sound absorbing material based on the above-described definition and actually visualizing an internal structure to obtain a proportion of air.

In addition, in a case of measuring the permeability of the porous sound absorbing material (sound absorbing material), first, the permeability can be measured by applying a pressure of air to the sound absorbing material, and measuring a flow rate passing through the sound absorbing material. The method of measuring the permeability is standardized in “ASTM D737—Air Permeability of Textile Fabrics” or ISO 9237.

Therefore, the measurement can be performed with a permeability tester conforming to these standards.

In these measurement methods, the permeability can be measured by applying air at a high pressure, such as in the permeability tester or permeability test device, to the sound absorbing material and measuring the pressure and the flow rate passing through the sound absorbing material. Examples of such a test device include “YG461E” manufactured by Ningbo Textile Instrument Factory.

The permeability may be obtained by performing numerical calculation on the air flowing inside the structure acquired by the SEM or the X-ray CT scan by fluid calculation such as the CFD module of COMSOL to calculate the applied pressure and the outflowing flow rate.

Here, using the above-described COMSOL, the fluid calculation was performed to reproduce the same configuration as in the experiment on the simulation. The sound absorbing material was a porous fluid model according to Darcy's law. The calculation was performed by varying the parameters.

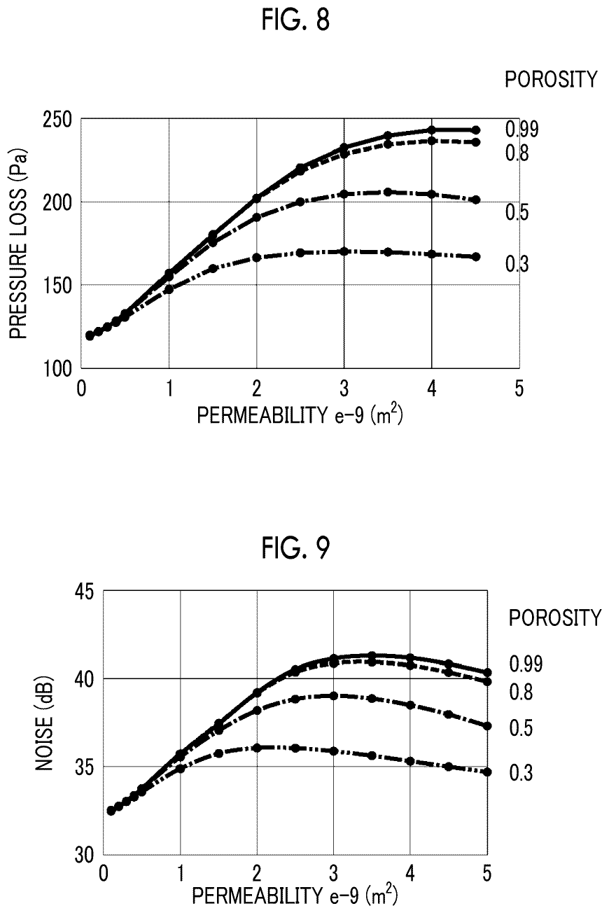

The measurement results of the pressure loss and the wind noise measured at the same position are shown in Tables 1 and 2 and FIGS. 8 to 11.

Pressure loss (Pa)

TABLE 1

| | Permeability (10⁻⁹ m²) | | | | | | |
|---|---|---|---|---|---|---|---|
| Porosity | 0.1 | 0.3 | 0.5 | 1 | 2 | 3 | 4 |
| 0.30 | 120 | 124 | 130 | 147 | 166 | 170 | 168 |
| 0.50 | 120 | 125 | 132 | 155 | 191 | 205 | 205 |
| 0.80 | 119 | 125 | 133 | 157 | 202 | 229 | 236 |
| 0.90 | 119 | 125 | 133 | 157 | 202 | 231 | 241 |
| 0.99 | 119 | 125 | 133 | 157 | 202 | 232 | 243 |

Wind noise (dBA)

TABLE 2

| | Permeability (10⁻⁹ m²) | | | | | | |
|---|---|---|---|---|---|---|---|
| Porosity | 0.1 | 0.3 | 0.5 | 1 | 2 | 3 | 4 |
| 0.30 | 32.5 | 33.0 | 33.6 | 34.9 | 36.1 | 35.9 | 35.3 |
| 0.50 | 32.5 | 33.0 | 33.7 | 35.5 | 38.2 | 39.0 | 38.5 |
| 0.80 | 32.5 | 33.0 | 33.7 | 35.7 | 39.2 | 40.9 | 40.7 |
| 0.90 | 32.5 | 33.0 | 33.7 | 35.7 | 39.2 | 41.0 | 41.0 |
| 0.99 | 32.5 | 33.0 | 33.7 | 35.7 | 39.2 | 41.1 | 41.2 |

FIG. 8 and Table 1 and FIG. 9 and Table 2 show a relationship between the sound absorbing material physical properties (permeability and porosity) at an incidence wind velocity of 20 m/s in a linear flow channel having a flow channel width of 25 mm and the magnitude of the pressure loss (Pa) and the wind noise (dB). Here, the permeability indicates a range of 0.1×10⁻⁹ m² to 5.0×10⁻⁹ m², and the porosity indicates a value in a case of 0.3 (30%), 0.5 (50%), 0.8 (80%), and 0.99 (99%).

As clear from FIG. 8 and Table 1, it can be seen that the pressure loss (Pa) is higher as the porosity is higher. In addition, it can be seen that, in a case in which the porosity is 0.3, 0.5, and 0.8, the permeability is in a range of 2.5 to 4.0×10⁻⁹ m² and the pressure loss (Pa) reaches a peak and is saturated, and in a case in which the porosity is 0.99, the pressure loss (Pa) is increased and is saturated even in a case in which the permeability exceeds 4.0×10⁻⁹ m².

As clear from FIG. 9 and Table 2, it can be seen that the wind noise (dB) is higher as the porosity is higher. In addition, it can be seen that, in a case in which the porosity is 0.3, 0.5, and 0.8, the permeability is in a range of 2.0 to 3.5×10⁻⁹ m² and the wind noise (dB) reaches a peak and is saturated, and in a case in which the porosity is 0.99, the permeability is 4.0×10⁻⁹ m², reaches a peak, and is saturated.

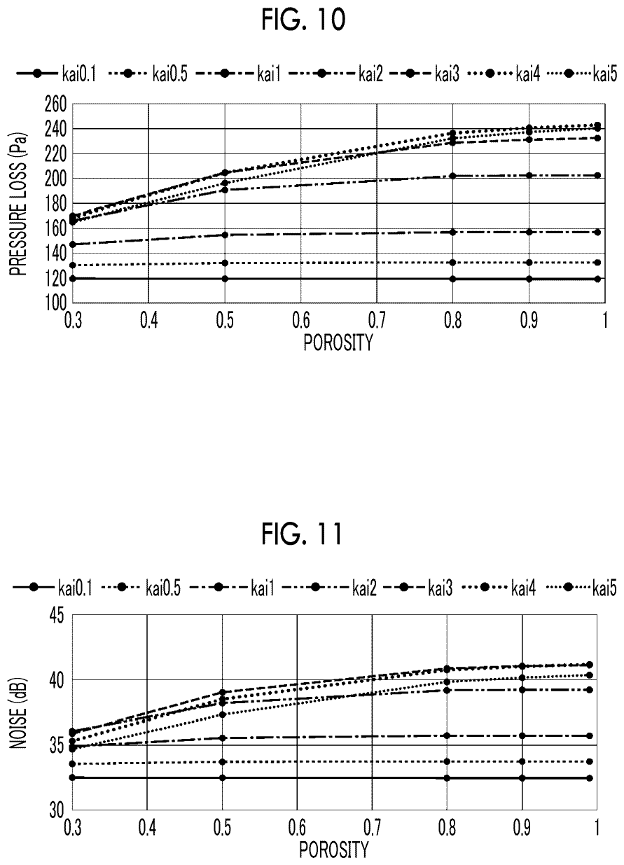

In addition, FIG. 10 and Table 1 and FIG. 11 and Table 2 show a relationship between the sound absorbing material physical properties (permeability and porosity) in a direct flow channel described above and the magnitude of the pressure loss (Pa) and the wind noise (dB). Here, the permeability indicates a value in a case of 0.1×10⁻⁹ m², 0.5×10⁻⁹ m², 1.0×10⁻⁹ m², 2.0×10⁻⁹ m², 3.0×10⁻⁹ m², 4.0×10⁻⁹ m², and 5.0×10⁻⁹ m², and the porosity indicates a range of 0.3 (30%) to 0.99 (99%). It should be noted that, in the drawing, kai represents the permeability (×10⁻⁹ m²).

As clear from FIG. 10 and Table 1, it can be seen that the pressure loss is higher as the permeability is higher in a region in which the permeability is small. In addition, it can be seen that the increase in pressure loss can be suppressed in a case in which the porosity is reduced.

In addition, as clear from FIG. 11 and Table 2, it can be seen that the sound is larger as the permeability is higher and the porosity is higher. In addition, it can be seen that the influence of the permeability is greater as the porosity is higher.

From the above, it can be seen that the porosity of the porous sound absorbing material 12 needs to be 0.9 (90%) or less and/or the permeability of the porous sound absorbing material 12 needs to be limited to 3.0×10⁻⁹ m² or less.

It can be also said that it is known that most of normal porous sound absorbing material currently used has the porosity exceeding 90%, and the porosity is high, the pressure loss is large, and the wind noise is large.

In a case in which only the acoustic aspect is considered, the Delany-Bazley law is established in a region in which the porosity is large and close to 1, and the law is generally used in a case in which the porosity is 0.9 or more. According to this law, the expression is simple and easy to handle in acoustic design, the characteristics are simple characteristics in which the sound absorption coefficient is higher as the frequency is higher, and thus it is easy to use. The weight is reduced with respect to the volume, and the material cost is also suppressed. Therefore, the sound absorbing material having large porosity is generally selected.

In the present invention, the flow resistance of the porous sound absorbing material 12 needs to be 1000 Rayls/m or more.

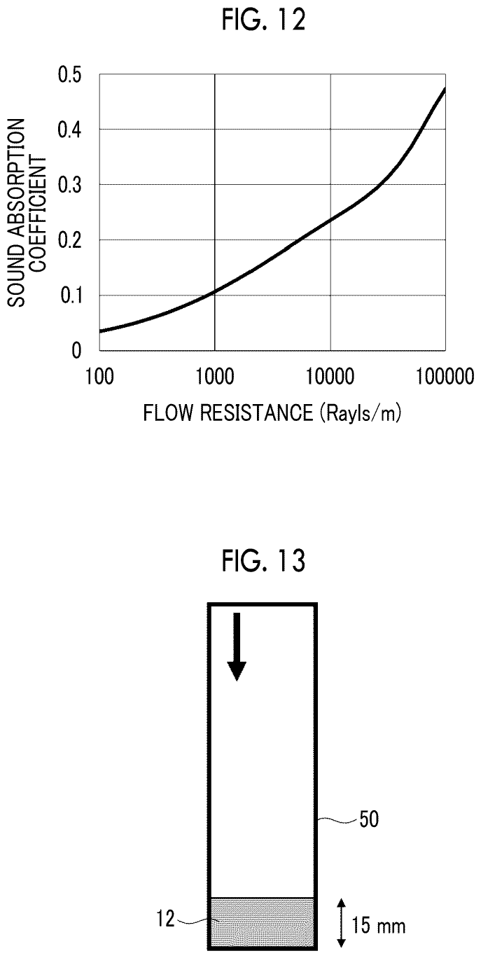

FIG. 12 is a graph showing a relationship between a normal incidence sound absorption coefficient of the porous sound absorbing material 12 measured using an acoustic pipe 50 shown in FIG. 13 and the flow resistance.

Here, the acoustic pipe 50 shown in FIG. 13 has an inner diameter of 30 mm and a length of 300 mm, and is used to measure the normal incidence sound absorption coefficient by disposing the porous sound absorbing material 12 of which a flow resistance value is known at a lower 15 mm area, causing a sound having a predetermined frequency to be vertically incident from the upper side, and measuring the reflected sound by a microphone (not shown) inside the acoustic pipe or on an acoustic pipe wall.

In the present invention, the reason why the flow resistance of the porous sound absorbing material 12 is limited to 1000 Rayls/m or more is that, as clear from FIG. 12, the normal incidence sound absorption coefficient for the sound of 1000 Hz exceeds 10% in a case in which the flow resistance exceeds 1000 Rayls/m. It should be noted that the sound of 1000 Hz is a sound on the lowest frequency side in an audible range of sound with the highest sensitivity. This sound of 1000 Hz is a sound that is 3.2 dB louder than a sound of 500 Hz and 8.6 dB louder than a sound of 250 Hz, and is a sound that is a reference value in an A characteristic which is the correction of the sensitivity of the human ear. Therefore, the sound is likely to be a target of a silencing problem.

Here, the flow resistance of the porous sound absorbing material 12 can be obtained according to ISO 9053.

That is, the front and rear differential pressure of the porous sound absorbing material 12, which is a sample, can be measured by a DC method (a method of applying a low wind velocity to the sample with a compressor and measuring the front and rear differential pressure) or an AC method (a method of generating an AC flow with a piston and measuring the differential pressure). By calculating the pressure difference/(wind velocity×sample thickness) from the differential pressure obtained in this way, that is, the pressure difference, the flow resistance can be actually measured.

It should be noted that, in the sample having large porosity, a result of the normal incidence sound absorption coefficient measurement using an acoustic pipe two-termination method (according to JISA 1405-2 and ISO 10534-2) and the thickness of the sample can be measured, and the flow resistance can be obtained by fitting using a sound absorbing model (Delany-Bazley model).

In the present invention, an average of flow channel widths W of the ventilation channel 18 and the ventilation channel 24 needs to be 100 mm or less.

Here, the measurement was performed in a system in which the flow channel width W was changed to 25 mm, 50 mm, 75 mm, 100 mm, and 125 mm by using the method of producing the sound absorbing material produced in Comparative Example 1, Example 1, and Example 2, which will be described later, as it is. In this case, the thickness of the portion of the sound absorbing material was kept at 15 mm.

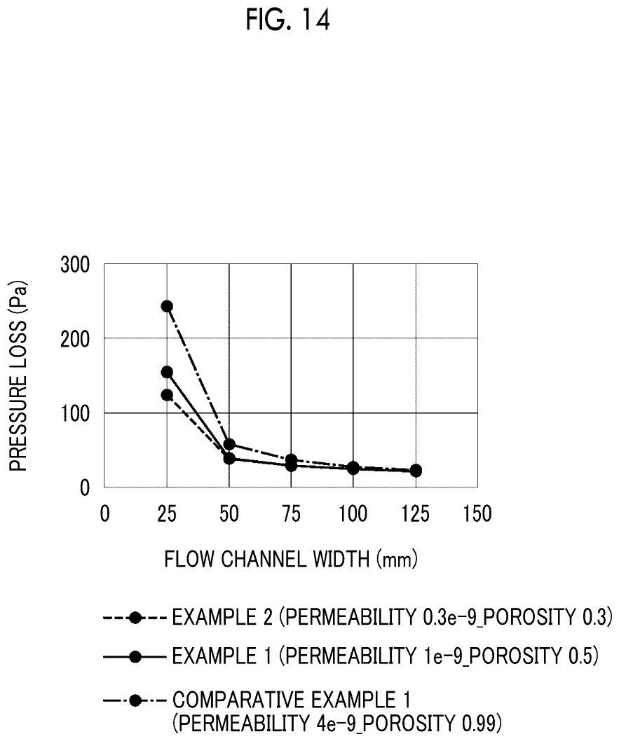

The pressure loss in each case is shown in Table 3 and FIG. 14.

TABLE 3

| | Sound | Sound | Sound |
|---|---|---|---|
| | absorbing | absorbing | absorbing |
| | material of | material of | material of |
| | Example 2 | Example 1 | Comparative |
| | (permeability | (permeability | Example 1 |
| | 0.3 × | 1 × | (permeability |
| Width | 10⁻⁹ m²_ | 10⁻⁹ m²_ | 4 × 10⁻⁹ m²_ |
| (mm) | Porosity 0.3) | Porosity 0.5) | Porosity 0.99) |
| Present | 124.4 | 154.8 | 243.0 |
| invention | | | |
| range 25 | | | |
| Present | 38.5 | 39.2 | 58.2 |
| invention | | | |
| range 50 | | | |
| Present | 29.2 | 29.3 | 37.0 |
| invention | | | |
| range 70 | | | |
| Present | 24.7 | 24.7 | 27.4 |
| invention | | | |
| range 100 | | | |
| Present | 21.5 | 21.5 | 23.4 |
| invention | | | |
| range 125 | | | |

Table 3 shows the pressure loss of the ventilation type silencer 10 using the sound absorbing materials of Examples 1 and 2, which can be used in the embodiment of the present invention, and the sound absorbing material of Comparative Example 1, which cannot be used in the embodiment of the present invention, as the porous sound absorbing material 12, and the value of the flow channel width of the ventilation channel 18, and FIG. 14 is a graph showing a relationship between the pressure loss of the ventilation type silencer 10 and the flow channel width of the ventilation channel 18.

In a case of obtaining Table 3 and the graph of FIG. 14, a two-dimensional flow channel (two side walls of the inner wall surface 13 were the sound absorbing materials 12) was used as the flow channel of the ventilation channel 18 of the ventilation type silencer 10, and the flow channel width was varied to 25 mm, 50 mm, 75 mm, 100 mm, and 125 mm. On the other hand, a wind velocity at an entrance of the ventilation channel 18 was fixed to 20 m/s. (It should be noted that, as the flow channel width is larger, the flow rate of the gas is larger in proportion.)

In addition, Table 3 and the graph of FIG. 14 could be obtained by setting the thickness of the sound absorbing material fixed to the side wall of the flow channel formation member 14 to 15 mm and varying the type of the sound absorbing material using three types of the sound absorbing material of Example 1 described later in which the permeability was 1.0×10⁻⁹ m² and the porosity was 0.5, the sound absorbing material of Example 2 described later in which the permeability was 0.3×10⁻⁹ m² and the porosity was 0.3, and the sound absorbing material of Comparative Example 1 described later in which the permeability was 4.0×10⁻⁹ m² and the porosity was 0.99.

As clear from Table 3 and FIG. 14, it can be seen that, in a case in which the width of the sound absorbing material is increased, the pressure loss is reduced, the original adverse effect is reduced, and the difference between the sound absorbing materials is also reduced.

In addition, from the above-described results, in a case in which the flow channel width was 25 mm, 50 mm, 75 mm, 100 mm, or 125 mm, a ratio of the pressure loss in the flow channel of the ventilation type silencer 10 between a case of the sound absorbing material of Comparative Example 1 and a case of the sound absorbing material of Example 2 was obtained. The results are shown in Table 4.

TABLE 4

| Flow channel | Sound absorbing material |
|---|---|
| width (mm) | difference ratio of pressure loss |
| 25 | 1.95 |
| 50 | 1.51 |
| 75 | 1.27 |
| 100 | 1.11 |
| 125 | 1.09 |

Therefore, as clear from FIGS. 14, and Tables 3 and 4, since the flow channel width is 100 mm or less in a range in which the original pressure loss is large and the influence of the sound absorbing material is also large, the flow channel width needs to be 100 mm or less.

The flow channel width is desirably 75 mm or less and more desirably 50 mm or less.

The porous sound absorbing material used in the embodiment of the present invention is not particularly limited, and a sound absorbing material known in the related art can be appropriately used. For example, various known sound absorbing materials can be used, such as a foam body, a form material (urethane foam (for example, “calmflex F series” manufactured by INOAC CORPORATION, polyurethane foam manufactured by Hikari Co., ltd., “MIF” manufactured by Sumitomo Riko Company Limited., and the like), soft urethane foam, sintered ceramic particles, phenol foam, melamine foam (“Basotect” manufactured by BASF), polyamide foam, and the like), a nonwoven sound absorbing material (a microfiber nonwoven fabric (for example, “Thinsulate” manufactured by 3M, “milife MF” manufactured by ENEOS Techno Materials Corporation, “micromat” manufactured by TAIHEI FELT Co., Ltd., and the like), polyester nonwoven fabric (for example, “White Cuon” manufactured by Tokyo Bouon, “QonPET” manufactured by Bridgestone KBG Co., Ltd., “SYNTHEFIBER” manufactured by TORAY INDUSTRIES, INC., and these products are provided in a two-layer structure with a high-density thin front surface nonwoven fabric and a low-density rear surface nonwoven fabric), plastic nonwoven fabric such as acrylic fiber nonwoven fabric, natural fiber nonwoven fabric such as wool and felt, metallic nonwoven fabric, glass nonwoven fabric, cellulose nonwoven fabric, and the like), other materials that contain tiny air bubbles (glass wool, rock wool, nanofiber-based sound absorbing materials (silica nanofiber, acrylic nanofiber (for example, “XAI” manufactured by Mitsubishi Chemical Group Corporation))).

Regarding a sound absorbing material provided with a plurality of layers different from each other in density like in a case of a two-layer structure with a high-density and low-porosity thin surface nonwoven fabric and a low-density and high-porosity rear surface nonwoven fabric layer and a case in which a polyurethane-based surface coating is attached, it is desirable that a layer of which the density is high (layer with low porosity) is disposed as the flow channel surface in the viewpoint of improving fluid characteristics (flow of wind). In addition, in a case in which the nonwoven fabric surface used by being bonded to a surface of the sound absorbing material in the related art such as a felt or a foam body, such as “Precise” manufactured by Asahi Kasei Corporation, is used, it is desirable to dispose a Precise surface having a high density (low porosity) on the flow channel side.

Examples of a forming material of the components other than the flow channel formation member 14, the gas flow pipe 22a and 22b, and the porous sound absorbing materials of the ventilation type silencer 10 and 20 include a metal material, a resin material, a reinforced plastic material, and carbon fiber. Examples of the metal material include metal materials such as aluminum, titanium, magnesium, tungsten, iron, steel, chromium, chromium molybdenum, nichrome molybdenum, and alloys thereof. Examples of the resin material include resin materials such as acrylic resin (PMMA), polymethyl methacrylate, polycarbonate, polyamide, polyalylate, polyetherimide, polyacetal, polyetheretherketone, polyphenylene sulfide, polysulfone, polyethylene terephthalate, polybutylene terephthalate (PET), polyimide, triacetylcellulose (TAC), polypropylene (PP), polyethylene (PE), polystyrene (PS), ABS resin (copolymer synthetic resin of acrylonitrile, butadiene, and styrene), flame-retardant ABS resin, ASA resin (copolymer synthetic resin of acrylonitrile, styrene, and acrylate), polyvinyl chloride (PVC) resin, and polylactic acid (PLA) resin. Also, examples of the reinforced plastic material include carbon fiber reinforced plastics (CFRP) and glass fiber reinforced plastics (GFRP).

From the viewpoint of the weight reduction, the case of molding, and the like, the resin material is preferably used as a material used in the ventilation type silencer. Also, as described above, from the viewpoint of the sound insulation in a low frequency region, it is preferable to use a material having high rigidity. From the viewpoint of the weight reduction and the sound insulation, the density of the member constituting the ventilation type silencer is preferably 0.5 g/cm³ to 2.5 g/cm³.

### EXAMPLES

Hereinafter, the present invention will be described in more detail based on the following examples. A material, a usage amount, a ratio, a processing content, a processing procedure, and the like shown in the following examples can be appropriately changed without departing from the gist of the present invention. Accordingly, the scope of the present invention should not be construed as being limited by the following examples.

### Comparative Example 1

As the porous sound absorbing material, a 40-mm thickness product of Thinsulate manufactured by 3M was used. The nonwoven fabric paper having a high density on the surface was peeled off, and an inner side nonwoven fabric layer in which the density is constant and low was targeted. The cutting was performed by scissors such that the thickness was 15 mm.

As the flow channel, a rectangular flow channel (flow channel formation member) made of acrylic having a flow channel width of 25 mm was created, a flow channel expansion part having four surfaces expanding by 15 mm was provided in the middle, and the part is filled with Thinsulate described above to create the ventilation channel consisting of the sound absorbing material flow channel. The flow channel expansion part had a length of 250 mm in a flow channel direction.

In a case in which the sound absorbing material filled with Thinsulate described above was measured by the above-described method, the flow resistance was 1500 Rayls/m, the porosity was 0.99, and the permeability was 4×10⁻⁹ m².

A manometer was provided at a position of 50 mm before and after the flow channel expansion part, and the differential pressure passing through the expansion part was measured. In addition, a microphone was attached to positions 200 mm away from the upstream side and the downstream side of the expansion part, and the wind noise volume generated at the expansion part was measured by a noise meter.

One side of the rectangular flow channel as the ventilation channel was opened, and an axial flow fan was attached to the other side to generate the wind having the wind velocity of 20 m/s.

In the measurement result, the pressure loss was 243 Pa and the wind noise volume was 41.1 dBA.

### Example 1

The above-described 40-mm product of Thinsulate was compressed without being cut to increase the density, thereby obtaining a sound absorbing material having a thickness of 15 mm.

The flow resistance of the sound absorbing material was 5000 Rayls/m, the porosity was 0.50, and the permeability was 1.0×10⁻⁹ m².

In the same manner as in Comparative Example 1, the sound absorbing material of the compressed Thinsulate was disposed in the rectangular flow channel as the ventilation channel, and the measurement was performed.

As a result, the pressure loss was 157 Pa, and the wind noise volume was 35.7 dBA, and the fluid loss was smaller than that of Comparative Example 1.

### Example 2

Two sheets of Thinsulate described above were laminated and compressed to obtain an sound absorbing material having a thickness of 15 mm.

The flow resistance of the sound absorbing material was 15000 Rayls/m, the porosity was 0.30, and the permeability was 0.3×10⁻⁹ m².

In the same manner as in Comparative Example 1, the sound absorbing material of the compressed two-sheet Thinsulate was disposed in the rectangular flow channel as the ventilation channel, and the measurement was performed.

As a result, the pressure loss was 124 Pa, and the wind noise volume was 33.0 dBA, and the fluid loss was further smaller than that of Example 1.

### Example 3

As the porous sound absorbing material, a 15-mm product of QonPET manufactured by Bridgestone KBG Co., Ltd. was used.

A sound absorbing material having a two-layer structure consisting of a thin and high-density nonwoven fabric layer and a low-density nonwoven fabric layer was used as it is.

The sound absorbing material was measured with the low-density nonwoven fabric layer as the front surface.

The flow resistance of the sound absorbing material was 8000 Rayls/m, the porosity was 0.90, and the permeability was 3.0×10⁻⁹ m².

In the same manner as in Comparative Example 1, this sound absorbing material was disposed in the rectangular flow channel as the ventilation channel with the low-density nonwoven fabric layer as the front surface, and the measurement was performed.

As a result, the pressure loss was 228 Pa, and the wind noise volume was 40.0 dBA, and the fluid loss was smaller than that of Comparative Example 1.

### Example 4

A sound absorbing material having the configuration of Example 3 was used to perform the measurement with the high-density nonwoven fabric exposed on the front surface side.

In a case in which the sound absorbing material was evaluated only on the high-density nonwoven fabric surface, the flow resistance was 50000 Rayls/m, the porosity was 0.30, and the permeability was 0.1×10⁻⁹ m².

In the same manner as in Comparative Example 1, this sound absorbing material was disposed in the rectangular flow channel as the ventilation channel with the high-density nonwoven fabric exposed on the front surface side, and the measurement was performed.

As a result, the pressure loss was 119 Pa, the wind noise volume was 32.0 dBA, and the fluid loss was smaller than that of Example 3 by turning the high-density surface to the front surface.

From the above-described results, the effects of the present invention are clear.

### EXPLANATION OF REFERENCES

10, 10a, 10b, 10c, 10d, 10e, 10f, 20: ventilation type silencer
12: porous sound absorbing material (sound absorbing material)
12a, 12b, 12c: sound absorbing material layer
13, 15a, 15b, 23a, 23b: inner wall surface
14: flow channel formation member
14a, 14b: flow channel formation part
14c: flow channel expansion part
16: side wall of flow channel
18, 24: ventilation channel
22a, 22b: gas flow pipe
26: claw or support
28: horn

What is claimed is:

1. A ventilation type silencer comprising:
a ventilation channel in which at least a part of a side wall of a flow channel of a gas is formed of a porous sound absorbing material,
wherein a flow resistance of the sound absorbing material is 1000 Rayls/m or more,
porosity of the sound absorbing material on at least a flow channel surface side is 0.9 or less, and
a minimum flow channel width on a cross section perpendicular to a flow direction of the gas in the ventilation channel is 100 mm or less.

2. The ventilation type silencer according to claim 1,
wherein the sound absorbing material is formed of two or more sound absorbing material layers,
porosity of the sound absorbing material layer that is an outermost layer on the flow channel surface side is 0.9 or less, and
the sound absorbing material layer having porosity of 0.9 or more is included in second and subsequent layers.

3. A ventilation type silencer comprising:
a ventilation channel in which at least a part of a side wall of a flow channel of a gas is formed of a porous sound absorbing material,
wherein a flow resistance of the sound absorbing material is 1000 Rayls/m or more, permeability of the sound absorbing material on at least a surface side is 3.0×10⁻⁹ m² or less, and
a minimum flow channel width on a cross section perpendicular to a flow direction of the gas in the ventilation channel is 100 mm or less.

4. The ventilation type silencer according to claim 3,
wherein porosity of the sound absorbing material on at least a flow channel surface side is 0.9 or less.

5. The ventilation type silencer according to claim 3,
wherein the sound absorbing material is formed of two or more sound absorbing material layers, and
permeability of the sound absorbing material layer that is an outermost layer on a flow channel surface side is 3.0×10⁻⁹ m² or less.

6. The ventilation type silencer according to claim 5,
wherein porosity of the sound absorbing material in the sound absorbing material layer that is the outermost layer on the flow channel surface side is 0.9 or less.

7. The ventilation type silencer according to claim 1,
wherein the flow channel is circular.

8. The ventilation type silencer according to claim 1,
wherein the flow channel is rectangular.

9. The ventilation type silencer according to claim 1, further comprising:
a flow channel formation member; and
a claw or a support for fixing the sound absorbing material to a side wall surface of the flow channel formation member.

10. The ventilation type silencer according to claim 1,
wherein a portion of the sound absorbing material and a portion of a non-sound absorbing material are connected to each other via a shape in which a cross-sectional area of the ventilation channel is gradually widened.

11. The ventilation type silencer according to claim 4,
wherein the sound absorbing material is formed of two or more sound absorbing material layers, and
permeability of the sound absorbing material layer that is an outermost layer on a flow channel surface side is 3.0×10⁻⁹ m² or less.

12. The ventilation type silencer according to claim 11,
wherein porosity of the sound absorbing material in the sound absorbing material layer that is the outermost layer on the flow channel surface side is 0.9 or less.

13. The ventilation type silencer according to claim 2,
wherein the flow channel is circular.

14. The ventilation type silencer according to claim 2,
wherein the flow channel is rectangular.

15. The ventilation type silencer according to claim 2, further comprising:
a flow channel formation member; and
a claw or a support for fixing the sound absorbing material to a side wall surface of the flow channel formation member.

16. The ventilation type silencer according to claim 2,
wherein a portion of the sound absorbing material and a portion of a non-sound absorbing material are connected to each other via a shape in which a cross-sectional area of the ventilation channel is gradually widened.
